(19) United States
(12) Patent Application Publication
(10) Pub. No.: US 2012/0120942 A1
(43) Pub. Date: May 17, 2012

(54) WIRELESS COMMUNICATION SYSTEM, TRANSMITTER AND WIRELESS COMMUNICATION METHOD

(75) Inventors: Yasuhiro Hamaguchi, Osaka (JP); Kazunari Yokomakura, Osaka (JP); Osamu Nakamura, Osaka (JP); Jungo Goto, Osaka (JP); Hiroki Takahashi, Osaka (JP)

(73) Assignee: SHARP KABUSHIKI KAISHA, Osaka-shi, Osaka (JP)

(21) Appl. No.: 13/378,949

(22) PCT Filed: May 31, 2010
(86) PCT No.: PCT/JP2010/059226

§ 371 Date: Jan. 20, 2012

(30) Foreign Application Priority Data
Jun. 19, 2009 (JP) 2009-146226

(51) Int. Cl. H04J 1/00; H04W 92/00

(52) U.S. Cl. 370/343

(57) ABSTRACT

To suppress deterioration of channel estimation accuracy even when a terminal moves at high speed in a system for switching among a plurality of insertion patterns of channel estimation signals, in a wireless communication system for using one of a plurality of types of frame formats with different insertion positions of a channel estimation symbol, and spreading data in the frequency domain to perform communications, the types of frame formats include at least a first frame format having a channel estimation symbol in which channel estimation signals are allocated to all subcarriers, and a second frame format having a channel estimation symbol in which a channel estimation signal and data is multiplexed, and PAPR characteristics of a subcarrier for data transmission in the second frame format are the same as PAPR characteristics of a subcarrier for transmitting a symbol assigned only the data.

### TECHNICAL FIELD

The present invention relates to techniques for using one of a plurality of types of frame formats with different insertion positions of a symbol for channel estimation, and spreading data in the frequency domain to perform communications.

### BACKGROUND ART

In the next-generation cellular system, as an uplink communication scheme, it has been considered using DFT-S-OFDMA (Discrete Fourier Transform Spread Orthogonal Frequency Division Multiple Access, also referred to as SC-FDMA: Single Carrier Frequency Division Multiple Access or DFT Precoded OFDM). In DFT-S-OFDM signals, signals are allocated in contiguous subcarriers, and have properties of single-carrier scheme signals.

Accordingly, it can be said that the scheme has remarkably good PAPR (Peak to Average Power Ratio) characteristics. Further, for the purpose of improving spectrum efficiency, the communication scheme called Clustered DFT-S-OFDM is proposed. This scheme is a scheme for dividing a frequency signal generated by DFT-S-OFDM into groups comprised of a plurality of subcarriers called Cluster, and using the frequency in a discrete manner, and is the scheme for permitting deterioration of PAPR characteristics and enhancing the frequency selective diversity effect and spectrum efficiency.

FIG. 8 is a block diagram illustrating a schematic configuration of a transmitter for transmitting DFT-S-OFDM signals. In FIG. 8, a scramble part 100 performs randomizing such as confidential processing on transmission data. A modulation part 101 performs error correction and digital modulation. A DFT Pre-coding part 102 performs Pre-coding by DFT. A channel estimation signal generation part 103 generates a channel estimation signal for demodulation. A selection part 104 switches between the transmission data and the channel estimation signal.

A resource map part 105 assigns data to transmit to subcarriers to transmit. Then, in generating DFT-S-OFDM signals, the resource map part 105 performs mapping on contiguous subcarriers, while in generating Clustered DFT-S-OFDM signals, mapping data to discrete subcarriers. In the invention, a unit for a mobile station to gain access to a base station is referred to as a resource block (hereinafter, abbreviated as RB), and the RB is assumed to be comprised of one or more subcarriers.

An OFDM signal generation part 106 generates an OFDM signal including a guard interval. An RF part 107 is comprised of analog circuits from a D/A conversion (digital/analog conversion) part to an antenna.

FIG. 9 is a diagram showing an example of a frame format to transmit a signal. In FIG. 9, the vertical direction represents the frequency, and the horizontal direction represents the time. In FIG. 9, the case of using 24 subcarriers is shown, and it is assumed that 1 RB is comprised of 12 subcarriers. Further, the case is shown where 1 frame is comprised of 14 OFDM symbols, and the channel estimation signal is used in the 4th symbol and 11th symbol. FIG. 9 shows an example where all the subcarriers are used as resources for the channel estimation signal in an OFDM symbol in which the channel estimation signal is inserted.

The frame format shown herein is shown in Non-patent Document 1. In addition, a communication scheme using the frame format as shown in Non-patent Document 1 is DFT-S-OFDM, and using Clustered DFT-S-OFDM is not the premise.

### PRIOR ART DOCUMENT

### Non-patent Document

Non-patent Document: 3gpp is 36.213

Non-patent Document: R01-090020

### DISCLOSURE OF INVENTION

### Problems to be Solved by the Invention

In the case of using the frame format as shown in FIG. 9, a receiver needs to estimate channels in other OFDM symbols from two channel estimation symbols. However, the interval at which a channel estimation symbol is transmitted is 6 OFDM, and in mobile communication, as the moving speed of a terminal increases, estimation accuracy of the channel deteriorates.

The invention was made in view of such circumstances, and it is an object of the invention to provide a wireless communication system, transmitter and wireless communication method for enabling deterioration of channel estimation accuracy to be suppressed even when a terminal moves at high speed in a system for switching among a plurality of insertion patterns of channel estimation signals.

### Means for Solving the Problem

(1) To attain the aforementioned object, the invention took measures as described below. In other words, a wireless communication system of the invention is characterized in that in a wireless communication system for using one of a plurality of types of frame formats with different insertion positions of a channel estimation symbol, and spreading data in the frequency domain to perform communications, the types of frame formats include at least a first frame format having a channel estimation symbol in which channel estimation signals are allocated to all subcarriers, and a second frame format having a channel estimation symbol in which a channel estimation signal and data is multiplexed in the frequency domain.

Thus, the types of frame formats include at least the first frame format having a channel estimation symbol in which channel estimation signals are allocated to all subcarriers, and the second frame format having a channel estimation symbol in which a channel estimation signal and data is multiplexed, and therefore, even when the moving speed of the terminal is high, it is possible to suppress deterioration of channel estimation accuracy.

(2) Further, in the wireless communication system of the invention, it is a feature that each of the types of frame formats includes the same number of subcarriers for data transmission for each frame.

Thus, each of the types of frame formats includes the same number of subcarriers for data transmission for each frame, and therefore, it is possible to change the density in the time-axis direction and the density in the frequency-axis direction of the channel estimation signal corresponding to the type of frame format. As a result, by increasing the density in the time-axis direction, it is possible to enhance channel estimation accuracy in the time domain. Further, the information transmission amount for each frame is not changed.

(3) Furthermore, in the wireless communication system of the invention, it is another feature that PAPR (Peak to Average Power Ratio) characteristics of a subcarrier for data transmission in the second frame format are the same as PAPR characteristics of a subcarrier for transmitting a symbol assigned only the data.

According to this configuration, it is possible to suppress deterioration of the PAPR (Peak to Average Power Ratio) characteristics of the subcarrier for data transmission in the second frame format.

(4) Still furthermore, in the wireless communication system of the invention, it is another feature that each of the channel estimation signal and the data is allocated at certain intervals in the frequency-axis direction in the second frame format.

Thus, each of the channel estimation signal and the data is allocated at certain intervals in the frequency-axis direction in the second frame format, and therefore, it is possible to suppress deterioration of the PAPR characteristics.

(5) Moreover, the wireless communication system of the invention is characterized by switching a frame format to use according to a parameter concerning moving speed of a transmission terminal.

Thus, the frame format to use is switched according to a parameter concerning moving speed of a transmission terminal, and therefore, it is possible to suppress deterioration of channel estimation accuracy due to the moving speed of the transmission terminal.

(6) Further, the wireless communication system of the invention is characterized by being able to use a plurality of types of communication schemes and determining one of the plurality of types of frame formats based on a communication scheme to use.

Thus, since one of the plurality of types of frame formats is determined based on a communication scheme to use, it is possible to reduce the control information amount to notify of the frame format, and system design is made ease.

(7) Furthermore, the wireless communication system of the invention is characterized in that the communication schemes include at least DFT-S-OFDM (Discrete Fourier Transform Spread Orthogonal Frequency Division Multiplexing) and Clustered DFT-S-OFDM, and that the first frame format having a channel estimation symbol in which channel estimation signals are allocated to all subcarriers is used in the case of using the DFT-S-OFDM, while the second frame format having a channel estimation symbol in which a channel estimation signal and data is multiplexed is used in the case of using the Clustered DFT-S-OFDM.

Thus, the first frame format having a channel estimation symbol in which channel estimation signals are allocated to all subcarriers is used in the case of using DFT-S-OFDM, while the second frame format having a channel estimation symbol in which a channel estimation signal and data is multiplexed is used in the case of using Clustered DFT-S-OFDM, and therefore, it is possible to select the frame format including the channel estimation symbol corresponding to PAPR characteristics of each scheme, and to respond to high-speed moving of the transmission terminal.

(8) Still furthermore, the wireless communication system of the invention is characterized by determining one of the plurality of types of frame formats based on a parameter concerning transmission power.

Thus, one of the plurality of types of frame formats is determined based on a parameter concerning transmission power, and therefore, it is possible to perform communications without considering distortion of a signal due to differences in PAPR characteristics.

(9) Moreover, in the wireless communication system of the invention, it is a feature that the parameter concerning transmission power is transmission power headroom (Power Headroom).

Thus, the parameter concerning transmission power is transmission power headroom (Power Headroom), and therefore, it is possible to perform communications without considering distortion of a signal due to differences in PAPR characteristics.

(10) Further, the wireless communication system of the invention is characterized by determining one of the plurality of types of frame formats based on a modulation scheme to use.

Thus, one of the plurality of types of frame formats is determined based on a modulation scheme to use, and therefore, it is possible to obtain channel estimation accuracy corresponding to the modulation scheme.

(11) Still furthermore, the wireless communication system of the invention is characterized by including symbols with different multiplexing ratios between the channel estimation signal and the data.

Thus, symbols with different multiplexing ratios between the channel estimation signal and the data are included, and therefore, corresponding to the type of frame format, it is possible to change both the density in the time-axis direction and the density in the frequency-axis direction of the channel estimation signal As a result, by increasing the density in the time-axis direction, it is possible to enhance channel estimation accuracy in the time domain.

(12) Moreover, a transmitter of the invention is a transmitter for using one of a plurality of types of frame formats with different insertion positions of a channel estimation symbol, and spreading data in the frequency domain to transmit, and is characterized by having a multiplex part that selects one of a first frame format having a channel estimation symbol in which channel estimation signals are allocated to all subcarriers, and a second frame format having a channel estimation symbol in which a channel estimation signal and data is multiplexed, and a transmission part that transmits the channel estimation signal and the data, where PAPR (Peak to Average Power Ratio) characteristics of a subcarrier for data transmission in the second frame format are the same as PAPR characteristics of a subcarrier for transmitting a symbol assigned only the data.

Thus, the types of frame formats include at least the first frame format having a channel estimation symbol in which channel estimation signals are allocated to all subcarriers, and the second frame format having a channel estimation symbol in which a channel estimation signal and data is multiplexed, and therefore, even when the moving speed and communication rate of the terminal are high, it is possible to suppress deterioration of channel estimation accuracy.

(13) Further, a wireless communication method of the invention is a wireless communication method for using one of a plurality of types of frame formats with different insertion positions of a channel estimation symbol, and spreading data in the frequency domain to perform communications, and is characterized by including at least a step of selecting one of a first frame format having a channel estimation symbol in which channel estimation signals are allocated to all subcarriers, and a second frame format having a channel estimation symbol in which a channel estimation signal and data is multiplexed, and a step of transmitting the channel estimation signal and the data, where PAPR (Peak to Average Power Ratio) characteristics of a subcarrier for data transmission in the second frame format are the same as PAPR characteristics of a subcarrier for transmitting a symbol assigned only the data.

Thus, the types of frame formats include at least the first frame format having a channel estimation symbol in which channel estimation signals are allocated to all subcarriers, and the second frame format having a channel estimation symbol in which a channel estimation signal and data is multiplexed, and therefore, even when the moving speed and communication rate of the terminal are high, it is possible to suppress deterioration of channel estimation accuracy.

### Advantageous Effect of the Invention

According to the invention, even in an environment that a transmission terminal moves at high speed, it is possible to suppress deterioration in accuracy of channel estimation performed in a receiver, and to construct an efficient communication system.

### BRIEF DESCRIPTION OF DRAWINGS

FIG. 1A is a diagram showing a basic frame format;

FIG. 1B is a diagram showing an example of an expanded frame format;

FIG. 1C is a diagram showing an example of another expanded frame format;

FIG. 1D is a frame format for a high-speed moving terminal;

FIG. 2 is a block diagram illustrating a schematic configuration of a transmitter according to Embodiment 1 of the invention;

FIG. 3 is a block diagram illustrating a schematic configuration of a transmitter according to Embodiment 2 of the invention;

FIG. 4 is a block diagram illustrating a schematic configuration of a transmitter according to Embodiment 3 of the invention;

FIG. 5 is a block diagram illustrating a schematic configuration of a receiver according to Embodiment 3 of the invention;

FIG. 6A is a frame format used in transmitting 64QAM;

FIG. 6B is a frame format used in transmitting 16QAM;

FIG. 6C is a frame format used in transmitting QPSK;

FIG. 7 is a diagram showing an example of a frame format according to Embodiment 4;

FIG. 8 is a block diagram illustrating a schematic configuration of a transmitter for transmitting a DFT-S-OFDM signal; and

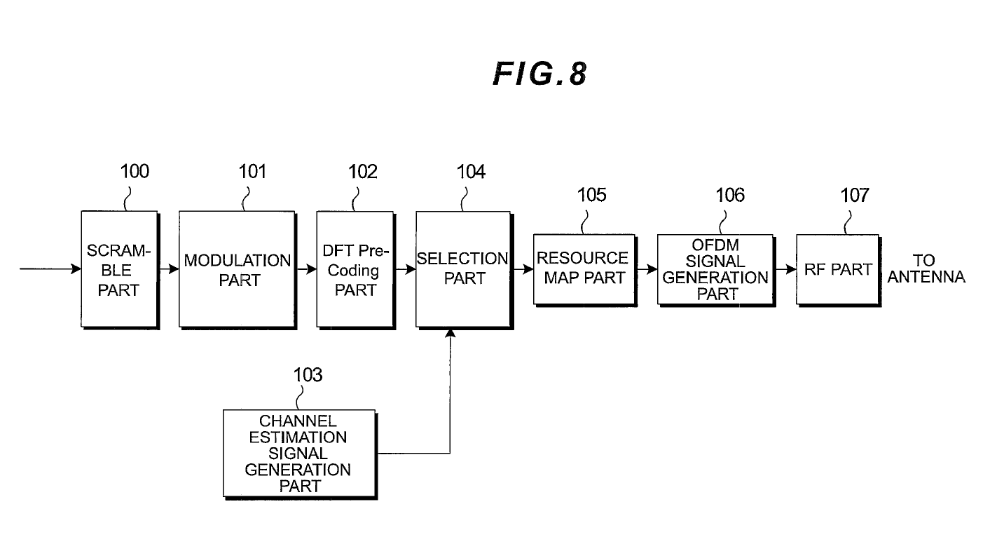

FIG. 9 is a diagram showing an example of a frame format to transmit a signal.

### BEST MODE FOR CARRYING OUT THE INVENTION

Embodiments of the invention will be described below with reference to drawings. In the following description, the description is given using uplink in which a mobile station apparatus transmits data to a base station apparatus, but the invention is not limited thereto. Further, the invention is described based on the premise that a transmission apparatus is capable of changing a transmission format on a transmission occasion basis (on a frame-by-frame basis or on a packet-by-packet basis) and transmitting data.

In the invention, a signal known between a transmitter and a receiver which is transmitted to estimate a channel is referred to as a channel estimation signal, and the channel estimation signal is capable of being assigned on a subcarrier-by-subcarrier basis. Further, a symbol including the channel estimation signal is referred to as a channel estimation symbol, and when channel estimation signals are not allocated to all subcarriers, it is possible to multiplex data. Further, Embodiments are based on the premise of using DFT-S-OFDM or Clustered DFT-S-OFDM as a communication scheme. These communication schemes are capable of being interpreted as OFDM signals obtained by spreading data in the frequency domain by DFT.

### Embodiment 1

This Embodiment first shows expanded frame formats with the same number of subcarriers for use in data transmission among frame formats that are expanded for high-speed mobile communication with respect to a basic frame format. In addition, in the frame formats, insertion intervals of the channel estimation symbol are different. Further, in consideration of the fact that PAPR characteristics are important in uplink, this Embodiment also shows a frame format for enabling deterioration of PAPR characteristics to be suppressed as possible.

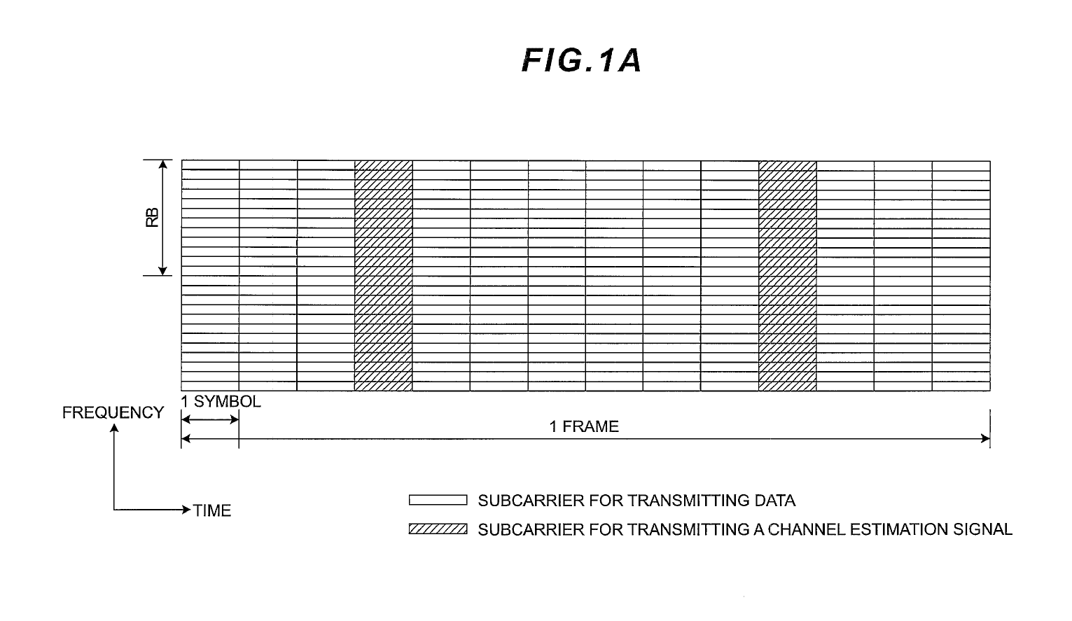

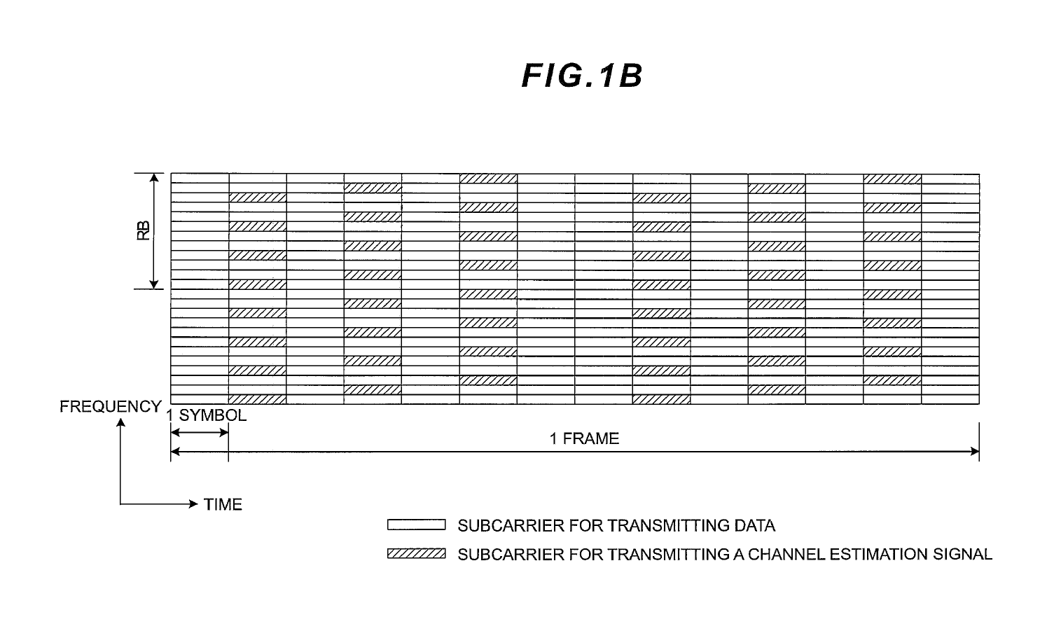

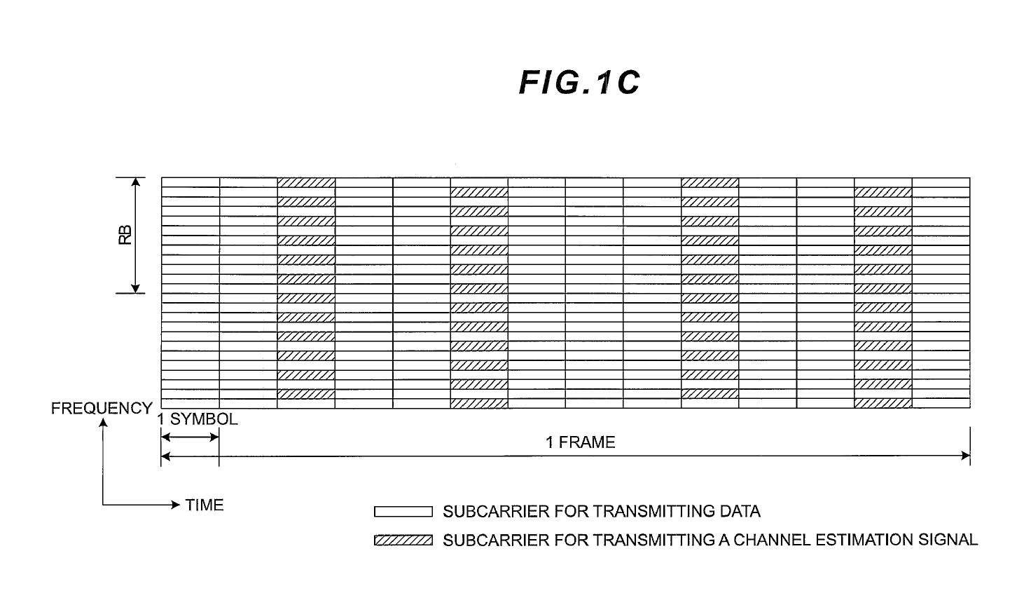

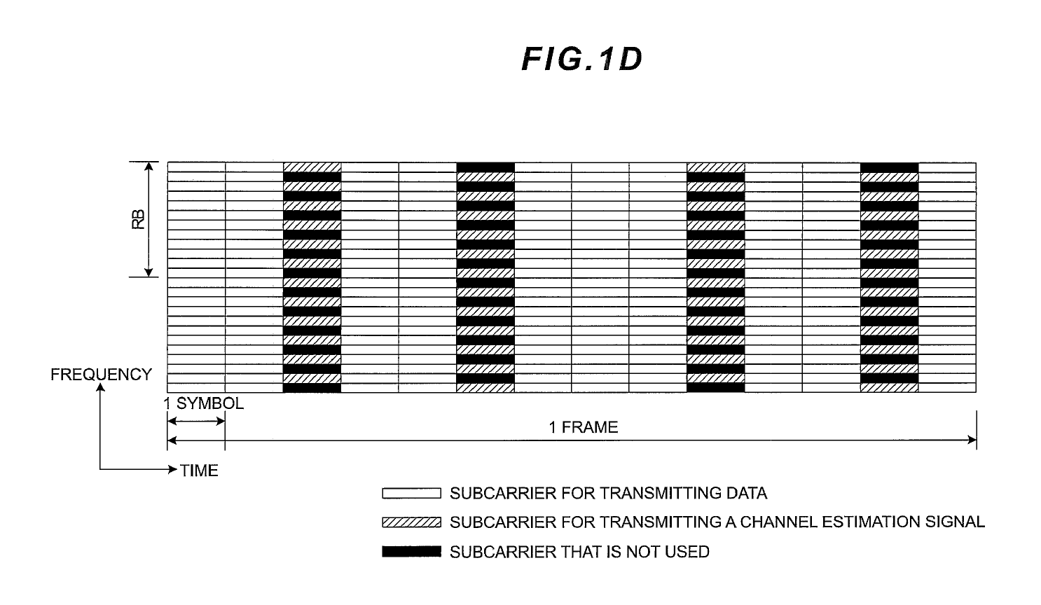

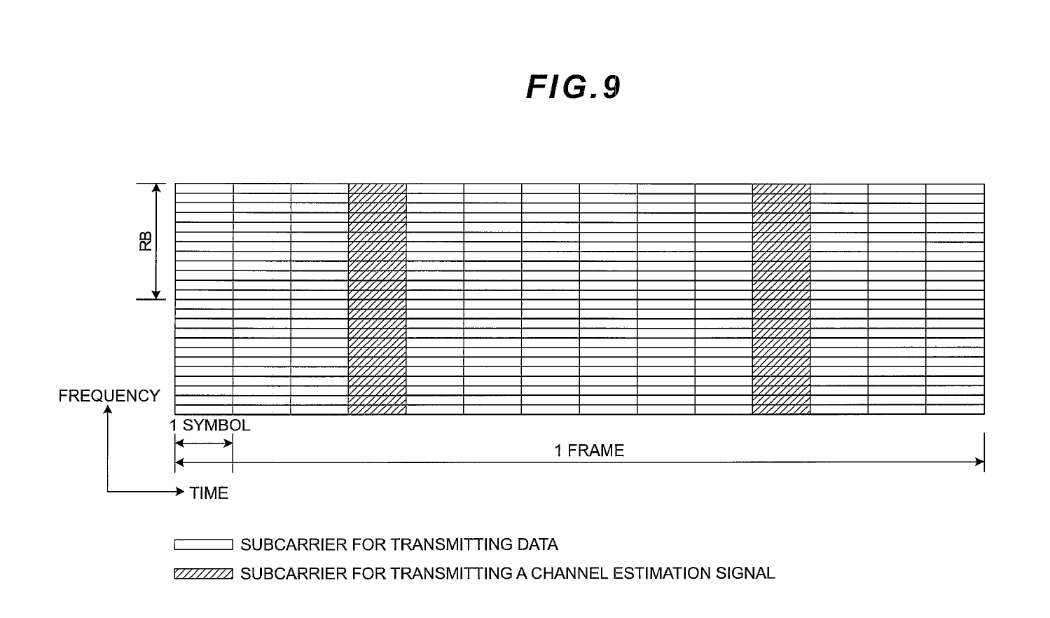

FIG. 1A is a diagram illustrating a basic frame format in this Embodiment. FIG. 1A is the same configuration as in FIG. 9. In the following description, this frame format is referred to as a “basic frame format”. In FIG. 1A, the vertical direction represents the frequency, and the horizontal direction represents the time. In FIG. 1A, the case of using 24 subcarriers is shown, and it is assumed that 1 RB is comprised of 12 subcarriers. Further, the case is shown where 1 frame is comprised of 14 OFDM symbols, and the channel estimation symbol is used in the 4th symbol and 11th symbol. The case of FIG. 1A is an example where all the subcarriers are used as resources for the channel estimation signal in an OFDM symbol in which the channel estimation symbol is inserted.

FIG. 1B is a diagram showing an example of an expanded frame format in the invention. (Hereinafter, this frame format is referred to as an “expanded frame format b”). As compared with FIG. 1A, the channel estimation symbol is inserted in the 2nd, 4th, 6th, 9th, 11th and 13th OFDM symbols. In addition, in the channel estimation symbol, channel estimation signals are not allocated to all subcarriers unlike FIG. 1A, and the channel estimation signal is set every three subcarriers. In other words, the channel estimation signal is inserted at the three-times density in the time-axis direction, while being inserted at the one-third density in the frequency-axis direction, and the number of subcarriers used in data transmission is thereby kept constant in FIGS. 1A and 1B.

First, in each channel estimation symbol, a receiver estimates a channel with respect to the frequency domain, then interpolates in the time domain, and thereby estimates channels of all the OFDM symbols. This means that it is possible to permit deterioration of channel estimation accuracy in the frequency domain and improve channel estimation accuracy in the time domain. In addition, the number of channel estimation signals required in the frequency domain is dependent on frequency selectivity (channel variation in the frequency domain) of the channel, and there are cases that reducing channel estimation signals in a channel estimation symbol is hardly a factor of deterioration.

In the wireless communication system using these two frame formats, for example, the mobile station notifies the base station of a parameter concerning moving speed, and the base station selects a format to use and notifies the terminal of the format to perform data communications. By this means, without changing the communication rate due to the moving speed of the terminal, even in an environment that the moving speed is high, it is possible to construct a communication system with deterioration of channel estimation accuracy suppressed. As the merits of no need for changing the communication rate of data, there is also no need of making a change of the frame format dependent on retransmission of data. This is because there is the case based on the premise that the data amount in retransmission is the same as in first transmission.

In the frame format as shown in FIG. 1B, the density of the channel estimation signal in the time-axis direction increases, and concurrently with decreasing the density in the frequency-axis direction, the data is multiplexed. In such a use method of subcarriers of the channel estimation symbol, PAPR characteristics deteriorate. This is caused by the fact that subcarriers for transmitting data are not contiguous, and by further multiplexing the channel estimation signal, deterioration of PAPR characteristics increases.

FIG. 1C is a diagram showing an example of another expanded frame format which is an expanded frame format in view of the above-mentioned issue. In the following description, the frame format is referred to as an expanded frame format c. The channel estimation symbol is inserted in the 3rd, 6th, 10th and 13th symbols. As in FIG. 1B, in the channel estimation symbol, channel estimation signals are not allocated to all subcarriers unlike FIG. 1A, and channel estimation signals are every two subcarriers.

In a DFT-S-OFDM signal, PAPR characteristics are the best in the case of using frequencies continuously, and in the case of using frequencies at certain intervals. In the frame format as shown in FIG. 1C (this state is a state having the feature of single-carrier), since subcarriers used for the channel estimation signal are allocated every two subcarriers, PAPR characteristics focusing on only subcarriers for transmitting data are almost the same as those of symbols other than channel estimation symbols. In other words, there are characteristics of single-carrier. Accordingly, PAPR characteristics in the channel estimation symbol are excellent as compared with those as shown in FIG. 1B, even in consideration of the fact that the channel estimation signal and data is multiplexed.

Accordingly, in addition to the feature of the frame format as shown in FIG. 1B, the frame format as shown in FIG. 1C has the merit that it is possible to suppress deterioration of PAPR characteristics as possible. Generally, PAPR characteristics in uplink are of an important factor, and it can be said that the frame format of FIG. 1C is an extremely useful format in uplink.

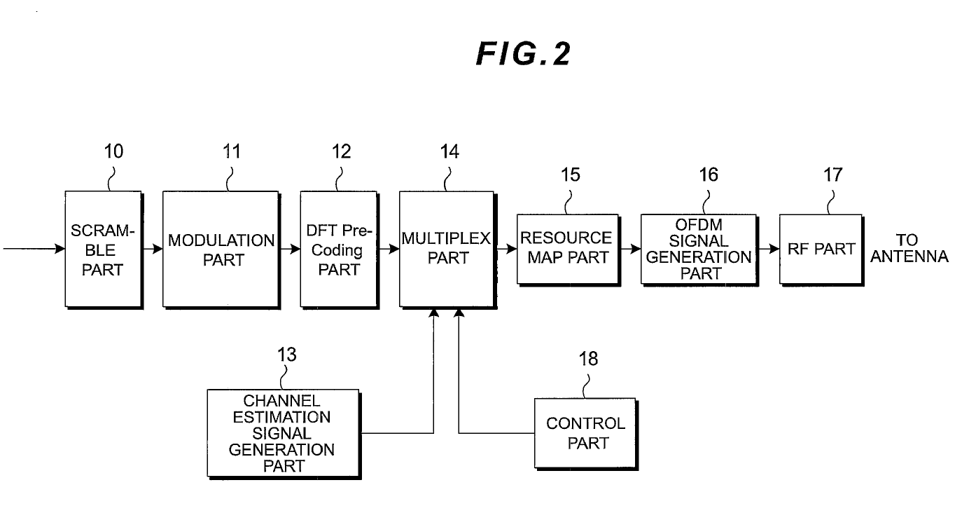

FIG. 2 is a block diagram illustrating a schematic configuration of a transmitter according to an Embodiment of the invention. In FIG. 2, a scramble part 10 performs randomizing such as confidential processing on transmission data. A modulation part 11 performs error correction and digital modulation. A DFT Pre-coding part 12 performs Pre-coding by DFT. A channel estimation signal generation part 13 generates a channel estimation signal for demodulation. A multiplex part 14 switches between the transmission data and the channel estimation signal by a control part 18. Further, the multiplex part 14 multiplexes the transmission data and the channel estimation signal by the control part 18.

A resource map part 15 assigns data to transmit to subcarriers to transmit. Further, in generating DFT-S-OFDM signals, the resource map part 15 performs mapping on contiguous subcarriers, while in generating Clustered DFT-S-OFDM signals, mapping data to discrete subcarriers. An OFDM signal generation part 16 generates an OFDM signal including a guard interval. An RF part 17 is comprised of analog circuits from a D/A conversion (digital/analog conversion) part to an antenna. The control part 18 controls the operation of the multiplex part 14.

In such a system that the base station designates a data format, the multiplex part 14 functions as a switching part at timing at which a channel estimation symbol is transmitted when the base station designates the frame format as shown in FIG. 1A, while functioning as a multiplex part when the base station designates the frame format as shown in FIG. 1B or FIG. 10.

As described above, according to Embodiment 1, various types of frame formats include at least the frame format (see FIG. 1A) having channel estimation symbols in which channel estimation signals are allocated to all subcarriers, and the frame format (see FIG. 1B or FIG. 1C) having channel estimation symbols in which a channel estimation signal and data is multiplexed, and therefore, even when the moving speed and communication rate of the terminal are high, it is possible to suppress deterioration of channel estimation accuracy.

### Embodiment 2

Embodiment 2 describes an Embodiment in which a frame format is changed according to an access scheme to use. In the next-generation uplink communication scheme, proposed is a method of switching between DFT-S-OFDM and Clustered DFT-S-OFDM (for example, see Non-patent Document 2: R01-090020). This is the method in an attempt to improve throughput characteristics of the cell by using DFT-S-OFDM excellent in PAPR characteristics in an environment such that a position of the terminal is at a cell edge where transmission power is limited, while using Clustered DFT-S-OFDM excellent in spectrum efficiency in an environment such as the center of the cell where transmission power has a margin.

Generally, a communication scheme (that may be called an access scheme) to use is notified from the base station to the mobile station via a downlink control channel. For example, in the case where there are two access schemes and two frame formats capable of being used, two information bits are required when notification is commonly performed. Since it is preferable that the information amount notified in downlink is fewer even by little, by uniquely defining the frame format according to the access scheme, it is possible to reduce the information amount, and in the case of the prior example, it is possible to respond by 1 bit. Further, when the access scheme has the characteristic in RBs to use such as DFT-S-OFDM and Clustered DFT-S-OFDM as the example shown herein, in other words, by determining that DFT-S-OFDM is used in the case of using frequencies continuously and that Clustered DFT-S-OFDM is used in the case of using frequencies discontinuously, it is possible to further reduce the information amount, and information bits except bits for designating RBs to use are not necessary.

Described next is a method for uniquely associating the communication scheme with the frame format. As described previously, in the case of using DFT-S-OFDM and Clustered DFT-S-OFDM separately in uplink in a cellular system, Clustered DFT-S-OFDM is used in the cell center because the effect of PAPR characteristics is small, and in this case, also as the frame format, the expanded frame format c in Embodiment 1 is used which permits deterioration of PAPR characteristics and is applicable to high-speed moving. Then, in the cell edge, since PAPR characteristics are important, the basic frame format is used. Thus, by linking characteristics of the communication scheme and characteristics of the frame format, system design is made ease, and as described previously, it is possible to construct a wireless communication system with the control information amount reduced.

Further, in the case of the system shown herein, when a high-speed moving terminal always selects Clustered DFT-S-OFDM as a communication scheme, it is possible to make the system hard to receive the effect caused by deterioration of channel estimation accuracy. Furthermore, since it is difficult that a high-speed moving terminal switches between Clustered DFT-S-OFDM and DFT-S-OFDM properly by transmission power, even when the terminal uses Clustered DFT-S-OFDM continuously, the effect shown in Non-patent Document 2, i.e. increases in throughput by switching between Clustered DFT-S-OFDM and DFT-S-OFDM by transmission power, is not decreased as the entire cell.

Herein, the description is given based on the premise that power of the channel estimation signal is the same as power of the data signal in the channel estimation symbol, and to compensate for deterioration of estimation accuracy in the frequency domain, it is also possible to increase power of the channel estimation signal. In this case, to make power in each symbol constant, power of a data signal is decreased. Thus, when the channel estimation signal and data is multiplexed in a channel estimation symbol, it is possible to set a transmission power difference, and to improve channel estimation accuracy. Further, when subcarriers for transmitting the channel estimation signal and data are provided with a power difference, PAPR characteristics are also improved as compared with the case of no power difference.

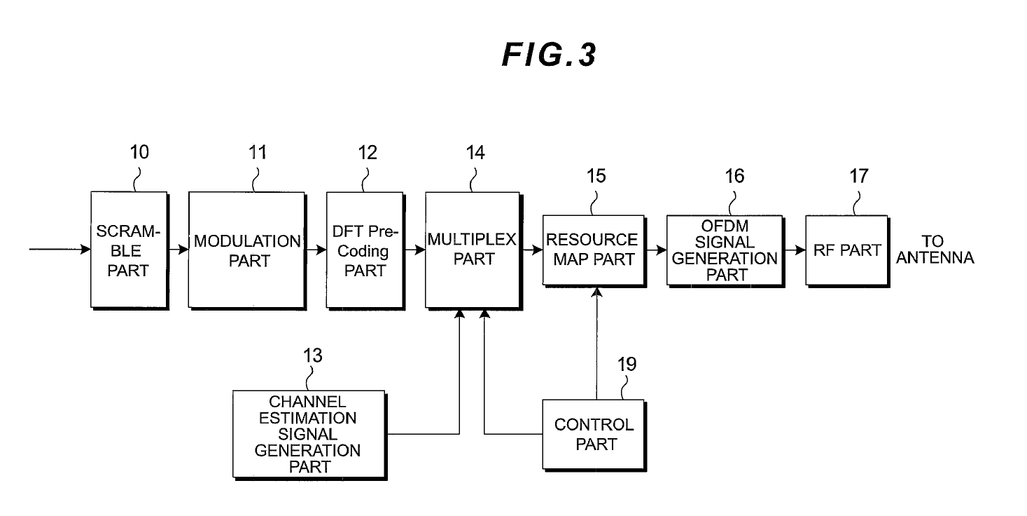

FIG. 3 is a block diagram illustrating a schematic configuration of a transmitter according to this Embodiment. The blocks of the same functions as in FIG. 2 are assigned the same reference numerals. Further, it is assumed that the communication scheme is switched between DFT-S-OFDM and Clustered DFT-S-OFDM. The difference between FIG. 2 and FIG. 3 is only a control part 19. When DFT-S-OFDM is selected as the communication scheme, the control part 19 controls the resource map part 15 to select continuous RBs, while controlling the multiplex part 14 to switch between the DFT-Precoding part 12 and the channel estimation signal.

When Clustered DFT-S-OFDM is selected as the communication scheme, the control part 19 controls the resource map part 15 to select discontinuous RBs, while controlling the multiplex part 14 to multiplex an output from the DFT-Precoding part 12 and an output from the channel estimation signal generation part 13.

As described above, according to Embodiment 2, the frame format (see FIG. 1A) having channel estimation symbols in which channel estimation signals are allocated to all subcarriers is used in the case of using DFT-S-OFDM, while the frame format (see FIG. 1B or FIG. 1C) having channel estimation symbols in which a channel estimation signal and data is multiplexed is used in the case of using DFT-S-OFDM, and therefore, while considering PAPR characteristics, it is possible to respond to high-speed moving of a transmission terminal.

### Embodiment 3

Embodiment 2 shows the case of using Clustered DFT-S-OFDM for a high-speed moving terminal as the communication scheme. However, since Clustered DFT-S-OFDM is poorer in PAPR characteristics than DFT-S-OFDM, the problem that power efficiency is poor is left. This Embodiment shows an example of switching the frame formats by transmission power based on the premise that a high-speed moving terminal uses DFT-S-OFDM as the communication scheme.

FIG. 1D is a frame format for high-speed moving terminals according to Embodiment 3. In FIG. 1D, there are subcarriers that data portions do not use, with respect to FIG. 1C. The number of subcarriers used in data communications is different between FIG. 1C and FIG. 1D, but the frame format has merits that PAPR characteristics in the channel estimation signal are excellent, while it is possible to allocate power of subcarriers that are not used to channel estimation signals, and that with respect to the subcarriers that are not used, it is possible to transmit channel estimation signals from another antenna. Hereinafter, this frame format is referred to as an expanded frame format d.

This Embodiment shows the method for switching the frame formats by transmission power, but in the method for changing the frame format by designation of the frame format from the base station, there is a case that it is not possible to respond to changes in the transmission power and frame format instantaneously. Accordingly, this Embodiment shows the example in which the mobile station selects a frame format by transmission power, and the base station estimates the frame format used in transmission and performs communications, but the invention is not applicable to only this Embodiment, and is naturally applicable to the system in which the base station selects the frame format.

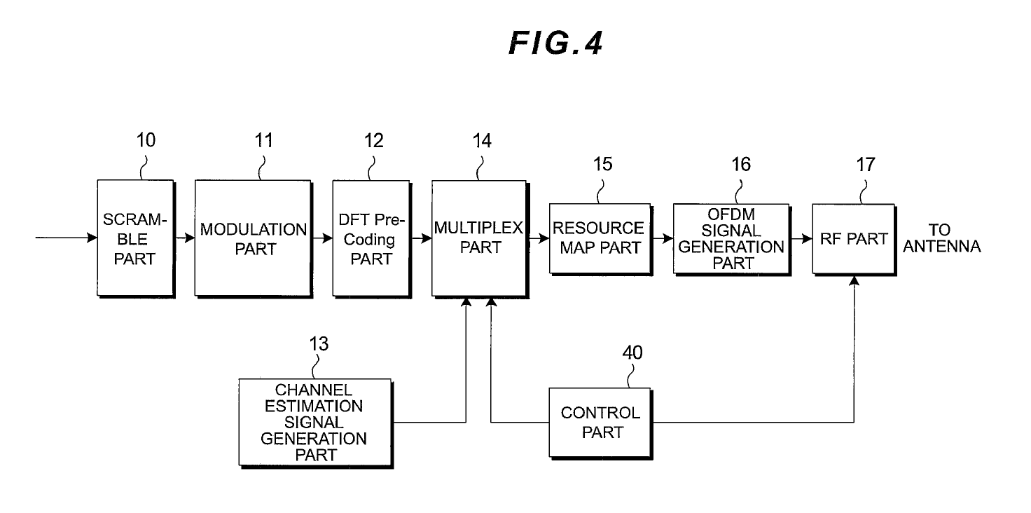

FIG. 4 is a block diagram illustrating a schematic configuration of a transmitter according to Embodiment 3. The blocks of the same functions as in FIG. 3 are assigned the same reference numerals. Further, it is assumed that the communication scheme is switched between DFT-S-OFDM and Clustered DFT-S-OFDM. The difference between FIG. 3 and FIG. 4 is only a control part 40. The control part 40 controls gain of a transmission power control amplifier that the RF part 17 has, while controlling so that in the multiplex part 14, the frame format is as shown in FIG. 1C when the transmission power is lower than a predetermined threshold, while being as shown in FIG. 1D when the transmission power is higher than the predetermined threshold. By thus controlling, it is possible to reduce the probability that the signal becomes distorted, and it is possible to maintain the transmission data amount as possible.

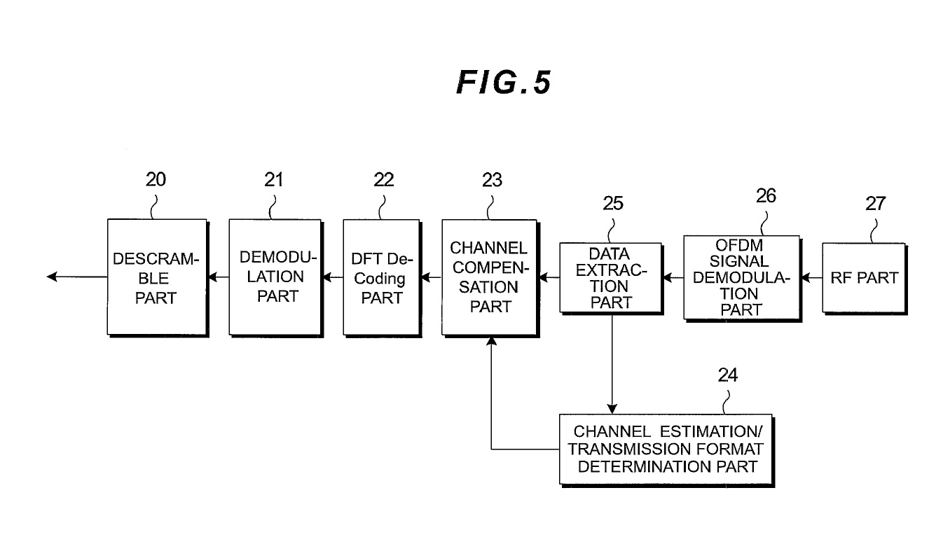

FIG. 5 is a block diagram illustrating a schematic configuration of a receiver according to Embodiment 3. Generally, since the receiver is a receiver of the base station, a plurality of users gains access at the same time, but to simplify the description, the case of demodulating a signal of one user is described. In FIG. 5, an RF part 27 converts a received signal into a signal enabling digital signal processing. An OFDM demodulation part 26 performs demodulation of an OFDM signal. A data extraction part 25 extracts data of a user to demodulate. A channel estimation/transmission format determination part 24 estimates a channel between the mobile station of the user to demodulate and the base station and determines a transmission format.

A channel compensation part 23 compensates the received data for the channel. A DFT-Decoding part 22 performs De-coding on the data subjected to Pre-coding in the transmission apparatus. A demodulation part 21 performs demodulation of QPSK or the like, error correction, etc. A descramble part 20 Cancels the scramble provided in the transmitter. In addition, in FIG. 5, the configuration is the configuration of the receiver in the conventional base station except the channel estimation/transmission format determination part 24.

When the frame format that the transmitter uses is the format as shown in FIG. 1C or FIG. 1D, the channel estimation/transmission format determination part 24 compares the average power between even-numbered carries and odd-numbered carriers in a channel estimation symbol. When the average power is almost the same, the part 24 performs channel estimation while assuming that the frame format c is transmitted. Meanwhile, when the difference is large, the part 24 performs channel estimation while assuming that the frame format d is transmitted. As other frame determination methods, there are a method of calculating correlation between the reception signal and the channel estimation signal, and another method for demodulating using both of the formats.

This Embodiment shows the case of switching the frame formats in accordance with the transmission power, and is applicable to parameters concerning the transmission power, and one of the parameters is transmission power headroom (Power Headroom: PH). PH is a value concerning a difference between maximum transmission power specific to the terminal and the transmission power, and in general, the negative value means that the signal becomes distorted. By thus switching the frame formats in accordance with the parameter concerning the transmission power, it is possible to perform communications without considering distortion of the signal due to the difference in PAPR characteristics.

Further, other than the PH, by changing the frame format corresponding to the modulation scheme, it is possible to improve communication characteristics. To simplify, the described is given using QPSK, 16QAM and 64QAM as the premise, but the invention is not limited thereto, and the modulation scheme also includes the coding rate of error correction. When the information amount capable of being transmitted in QPSK is assumed to be “1”, it is possible to transmit the information amount of 2 in 16QAM and the information amount of 3 in 64QAM.

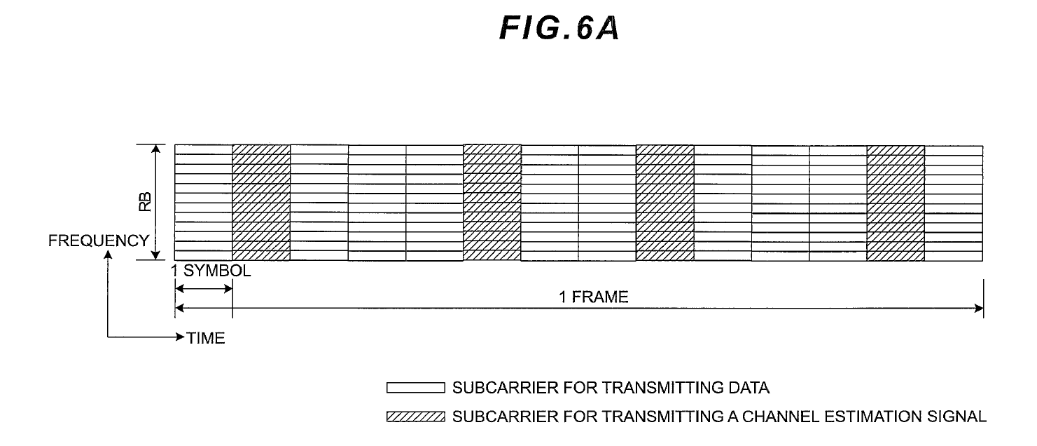

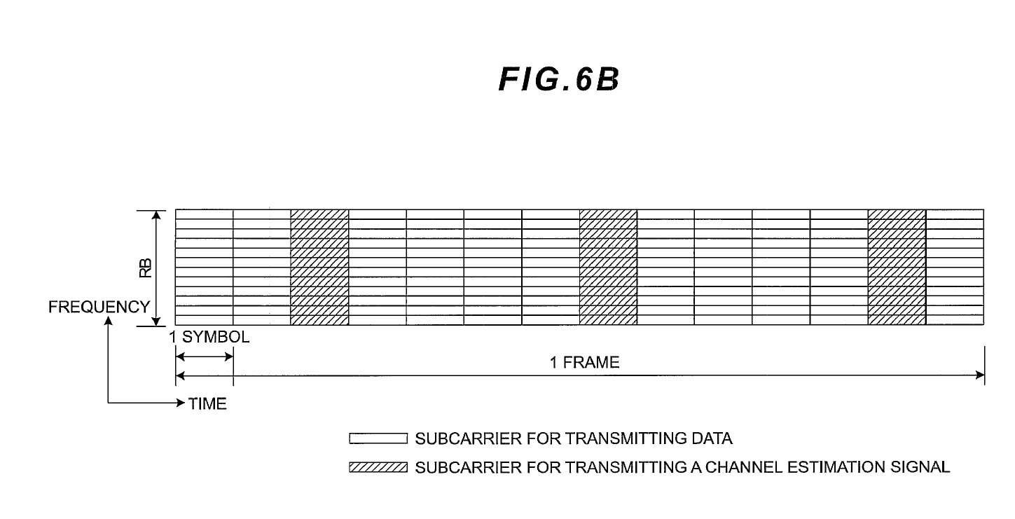

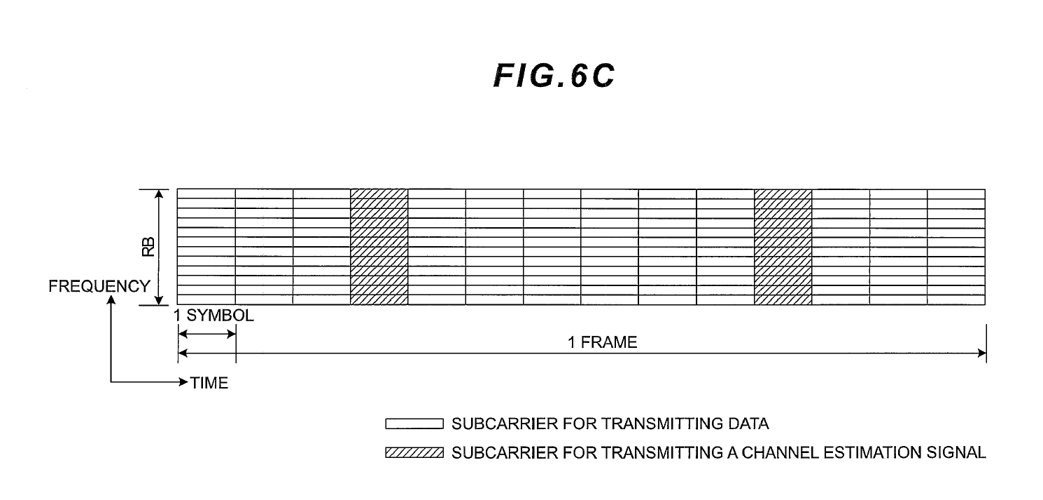

FIGS. 6A to 6C are diagrams showing an example of frame formats according to this Embodiment FIG. 6A shows a frame format used in transmitting 64QAM, FIG. 6B shows a frame format used in transmitting 16QAM, and FIG. 6C shows a frame format used in transmitting QPSK. Generally, as the modulation level of M-ary modulation increases, accuracy required of channel estimation is higher. This Embodiment uses frame formats that enable channel estimation accuracy to be obtained corresponding to the respective modulation level by changing the number of channel estimation symbols in the time domain. This example shows the method of changing the number of channel estimation symbols in the time domain, but applicable are the method of changing the number of channel estimation signals in the frequency domain, and the method of concurrently changing both the number of channel estimation signals in the frequency domain and the number of channel estimation symbols in the time domain.

As described above, according to Embodiment 3, one of a plurality of types of frame formats is determined based on a modulation scheme to use, and therefore, it is possible to obtain channel estimation accuracy corresponding to the modulation scheme.

### Embodiment 4

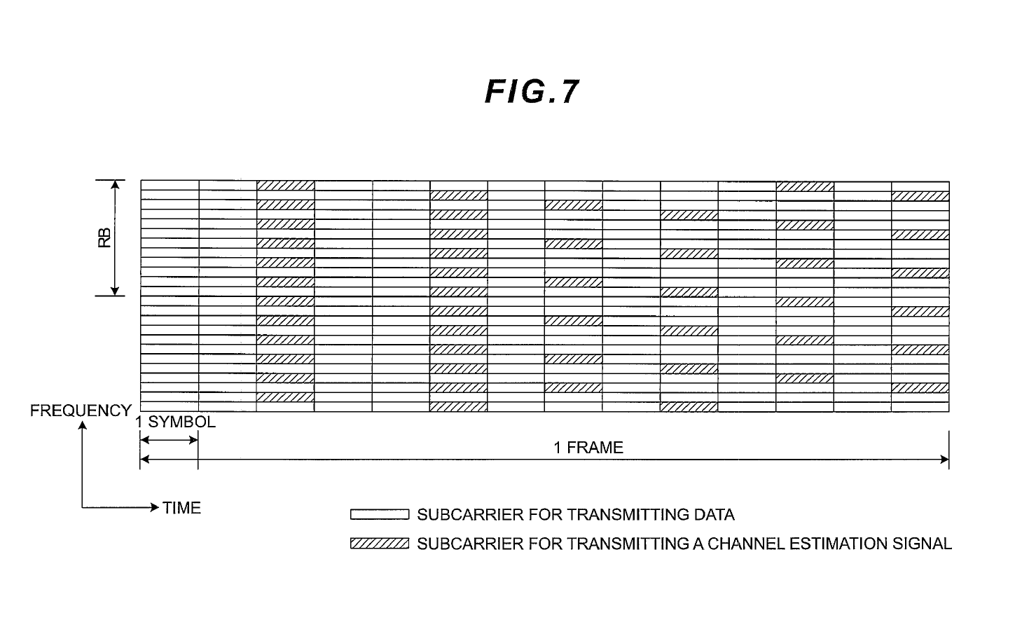

FIG. 7 is a diagram showing an example of a frame format according to Embodiment 4. In this Embodiment, the format includes symbols with different multiplexing ratios between the channel estimation signal and the data. As shown in FIG. 7, in the 3rd and 6th symbols in the first half of one frame, the subcarrier for transmitting the data and the subcarrier for transmitting the channel estimation signal are allocated alternately, and in the 8th, 10th, 12th and 14th symbols in the latter half of one frame, among the subcarriers for transmitting the data, the subcarriers for transmitting the channel estimation signal are allocated every four subcarriers. Thus, symbols with different multiplexing ratios between the channel estimation signal and the data are included, and therefore, corresponding to the type of the frame format, it is possible to change both the density in the time-axis direction and the density in the frequency-axis direction of the channel estimation signal. As a result, by increasing the density in the time-axis direction, it is possible to enhance channel estimation accuracy in the time domain.

In the aforementioned description, the invention is described based on the case that a transmission terminal moves at high speed as the premise, but is not limited thereto, and it is obvious that the invention is capable of being used in communications with the transmission terminal with a fast variation in time of a channel received in the reception apparatus.

### DESCRIPTION OF SYMBOLS

10 Scramble part
11 Modulation part
12 DFT Pre-coding part
13 Channel estimation signal generation part
14 Multiplex part
15 Resource map part
16 OFDM signal generation part
17 RF part
18, 19, 40 Control part

1. A wireless communication system for using one of a plurality of types of frame formats with different insertion positions of a channel estimation signal, and spreading data in the frequency domain to perform communications,
wherein the types of frame formats include at least a first frame format having a channel estimation symbol in which channel estimation signals are allocated to all subcarriers, and a second frame format having a channel estimation symbol in which a channel estimation signal and data is multiplexed in the frequency domain, and
each of the types of frame formats includes the same number of subcarriers for data transmission for each frame.

2. The wireless communication system according to claim 1, wherein as the frame formation in which the channel estimation signal and data is multiplexed, a frame format in which data is not transmitted in a symbol including the channel estimation signal is included.

3. The wireless communication system according to claim 1, wherein PAPR (Peak to Average Power Ratio) characteristics of a subcarrier for data transmission in the second frame format are the same as PAPR characteristics of a subcarrier for transmitting a symbol assigned only the data.

4. The wireless communication system according to claim 1, wherein each of the channel estimation signal and the data is allocated at certain intervals in the frequency-axis direction in the second frame format.

5. The wireless communication system according to claim 1, wherein a frame format to use is switched according to a parameter concerning moving speed of a transmission terminal.

6. The wireless communication system according to claim 1, wherein a plurality of types of communication schemes are capable of being used, and one of the plurality of types of frame formats is determined based on a communication scheme to use.

7. The wireless communication system according to claim 6, wherein the communication schemes include at least DFT-S-OFDM (Discrete Fourier Transform Spread Orthogonal Frequency Division Multiplexing) and Clustered DFT-S-OFDM, and
the first frame format having a channel estimation symbol in which channel estimation signals are allocated to all subcarriers is used in the case of using the DFT-S-OFDM, while the second frame format having a channel estimation symbol in which a channel estimation signal and data is multiplexed is used in the case of using the Clustered DFT-S-OFDM.

8. The wireless communication system according to claim 1, wherein one of the plurality of types of frame formats is determined based on a parameter concerning transmission power.

9. The wireless communication system according to claim 8, wherein the parameter concerning transmission power is transmission power headroom (Power Headroom).

10. The wireless communication system according to claim 1, wherein one of the plurality of types of frame formats is determined based on a modulation scheme to use.

11. The wireless communication system according to claim 1, wherein symbols with different multiplexing ratios between the channel estimation signal and the data are included.

12. A transmitter for using one of a plurality of types of frame formats with different insertion positions of a channel estimation symbol, and spreading data in the frequency domain to transmit, comprising:
a multiplex part that selects one of a first frame format having a channel estimation symbol in which channel estimation signals are allocated to all subcarriers, and a second frame format having a channel estimation symbol in which a channel estimation signal and data is multiplexed; and a transmission part that transmits the channel estimation signal and the data,
wherein PAPR (Peak to Average Power Ratio) characteristics of a subcarrier for data transmission in the second frame format are the same as PAPR characteristics of a subcarrier for transmitting a symbol assigned only the data.

13. A wireless communication method for using one of a plurality of types of frame formats with different insertion positions of a channel estimation symbol, and spreading data in the frequency domain to transmit, including at least the steps:
selecting one of a first frame format having a channel estimation symbol in which channel estimation signals are allocated to all subcarriers, and a second frame format having a channel estimation symbol in which a channel estimation signal and data is multiplexed: and
transmitting the channel estimation signal and the data,
wherein PAPR (Peak to Average Power Ratio) characteristics of a subcarrier for data transmission in the second frame format are the same as PAPR characteristics of a subcarrier for transmitting a symbol assigned only the data.

14. A wireless communication system for using one of a plurality of types of frame formats with different insertion positions of a channel estimation signal, and spreading data in the frequency domain to perform communications,
wherein the types of frame formats include at least a first frame format having a channel estimation symbol in which channel estimation signals are allocated to all subcarriers, and a second frame format having a channel estimation symbol in which a channel estimation signal and data is multiplexed in the frequency domain.
